(19) United States
(12) Patent Application Publication
(10) Pub. No.: US 2006/0110511 A1
(43) Pub. Date: May 25, 2006

(54) Formula digestible milk

(76) Inventor: Roger Namkoong, Tacoma, WA (US)

Correspondence Address: Leggett & Kram, 1901 South I Street, Tacoma, WA, 98405, US

(21) Appl. No.: 10/932,461

(22) Filed: Nov. 22, 2004

(51) Int. Cl. A23L 3/16

(52) U.S. Cl. 426/521

(57) ABSTRACT

An improved process for making whole milk digestible to lactose intolerant persons while maintaining the texture and flavor of whole milk comprised of adding sugar and Brewers Top yeast to whole milk and allowing it to ferment at temperature for a period of time then stopping the fermentation process and killing the yeast with heat, leaving beneficial enzymes in the milk and the product produced thereby.

### CROSS-REFERENCE TO RELATED APPLICATIONS

NONE

### STATEMENT REGARDING FEDERALLY SPONSORED RESEARCH OR DEVELOPMENT

NONE

### REFERENCE TO A “SEQUENCE LISTING,” A TABLE, OR A COMPUTER PROGRAM LISTING APPENDIX SUBMITTED ON A COMPACT DISC (SEE 37 CFR 1.52(e)(5))

NONE

### BACKGROUND OF THE INVENTION

(1) Field of the Invention

This invention relates generally to food preparation and in particular to a process for developing beneficial enzymes in cow's milk through a fermentation process so as to make it more easily digestible by lactose intolerant persons and the product produced thereby.

(2) Description of Related Art Including Information Disclosed Under 37 CFR 1.97 and 1.98

It has been long known that some persons have difficulty digesting whole cow's milk and efforts began as early as U.S. Pat. No. 1,080,920, 9 Dec., 1913 of P. Muller to try and alter cow's milk so that it would be more digestible. Yeasts, of various types, have long been added to milk products to change its texture and taste, such as disclosed in U.S. Pat. No. 455,210 issued 30 Jun., 1891 to J. J. Hooker, U.S. Pat. No. 2,809,113 issued Oct. 8, 1957 to E. G. Stimpson U.S. Pat. No. 5,055,309 issued Oct. 8, 1991 to T. Saita and U.S. Pat. No. 6,753,022 issued 22 Jun., 2004 to R. Vermin. Creating enzymes in cow's milk has also been known to change the nature of lactose to make it more digestible, U.S. Pat. No. 2,681,858 issued 22 Jun., 1954 to E. G. Stimpson. The type of yeast added to the milk product will impact the nature of the process and the resulting product as described by P. Galzy in U.S. Pat. No. 3,981,773 issued 21 Sep., 1976.

The prior art either resulted in a change of the texture and/or taste of the cow's milk product, such as J. H. Hooker, U.S. Pat. No. 455,210, E. G. Stimpson's U.S. Pat. No. 2,681,858, T. Saita's U.S. Pat. No. 5,055,309 and R. Vermin's U.S. Pat. No. 6,753,022, or it changed the lactose to a different form, E. G. Stimpson U.S. Pat. No. 2,809,133, P. Galzy U.S. Pat. No. 3,981,773. None of the prior art disclosed adding enzymes to cow's milk products which make them more digestible to persons with a lactose intolerance, which is common to persons of Asian extraction, while retaining the milk's texture and flavor. It is well known that some people do not have sufficient enzymes in their intestines to properly digest lactose and that the ingestion of enzymes in tablet form taken with the milk product will aid in digestion.

### BRIEF SUMMARY OF THE INVENTION

Accordingly, it is an object of this invention to provide an improved means of creating beneficial enzymes in cows whole milk to make it more digestible to persons suffering from lactose intolerance while maintaining its texture and flavor and the product produced thereby.

It is a further object of this invention to provide a cow's whole milk product which is digestible to persons suffering from lactose intolerance which has the same flavor, texture and storage requirements as untreated whole milk and can be utilized to make the wide range of milk products, such as ice cream.

The invention, both as to its process and its resulting product, together with further objectives and advantages thereof, may best be understood by reference to the following description.

These objects are accomplished in accordance with the invention by adding granulated sugar and brewer's top yeast to whole milk, raising the temperature in an aerobic environment to facilitate fermentation and, then, sterilizing the product with heat which stops the fermentation process and kills the yeast while creating the necessary beneficial enzymes which facilitate the digestion of the product in persons, to include those who are lactose intolerant.

### BRIEF DESCRIPTION OF THE SEVERAL VIEWS OF THE DRAWINGS

NONE

### DETAILED DESCRIPTION OF THE INVENTION

According to the invention, granulated sugar is added to a volume of whole cow's milk, which has already been pasteurized, at a ration of 10-30 grams of sugar per liter of milk. The amount of sugar added determines the length of the fermentation process, the degree of pre-digestion of the milk and the amount of enzymes created, i.e. the more sugar added the longer the fermentation process can be maintained with the resulting increase in the digestion of the milk. However, the product becomes unpalatable after the limit of 30 grams of granulated sugar per liter of milk is added. The amount of pre-digestion desired is based upon the sensitivity of the consumer to cow's milk so products of various levels of pre-digestion are envisioned.

The resulting solution is placed into a stainless steel container, which has a loose fitting lid to allow escape of off-gases from the fermentation process and inflow of ambient air for the aerobic process. To this solution is added yeast to activate the fermentation process. There are many forms of yeast: Saccharomyces sake, Saccharomyces ellipsoldeus, Zygosaccharomyces, Zygosaccharomyces soja, Zygosaccharomyces major, Zygosaccharomyces salsus, Mycoderma, Candida, but only Saccharomyces cervisiae, beer brewing top yeast, will produce the desired results, although Fleischmann's Bread Yeast can be used. This form of yeast, Beer Brewing Top Yeast, is more active than the Beer Brewing Bottom Yeast and is wide range yeast so that it makes more enzymes. The fermentation takes place in the top portion of the solution. This Beer Brewing Top Yeast is added to the solution at a ratio of 2-8 grams of yeast per liter.

The solution is then heated to between 15 and 38 degrees Celsius and held in that temperature range for 6 to 12 hours, during which time the fermentation process continues. The time for fermentation is determined by the amount of sugar added to the solution, the more sugar the longer the fermentation process and the greater number of enzymes created. However, allowing the fermentation process to continue more than 12 hours will result in coagulation of the solution. The temperature is a function of the capabilities of the equipment and is not critical to the process, so long as the temperature is kept within the range 15 to 38 degrees Celsius for the required time. The higher in the range of the amount of yeast added and the temperature at which the fermentation process takes place the faster the requisite number of enzymes are created in the solution. Thus, by adding 8 grams of yeast to the solution and heating it to 38 degrees Celsius, the fermentation process can be completed in a few as 6 hours.

This fermentation process creates the following enzymes in the solution: Carbohydrase, Protease, Oligase, Erepsine, Cellulose, Coagulase, Lactase, Phosphotase, Polyase, Oxidase, Nuclease, and Lecithase.

Upon expiration of the requisite time, the fermentation process is stopped by raising the solution to 60-70 degrees Celsius and holding it there for 40 minutes or raising the temperature of the solution to 120 degrees Celsius for 2 seconds, depending upon the capability of the equipment. This heating kills the yeast and stops the fermentation process. The finished product can be stored and distributed in any commercial milk container means and must be kept refrigerated and otherwise handled identical to pasteurized whole milk.

I claim:

1. An improved method for treating pasteurized whole cow's milk, so that it is more digestible to persons who are lactose intolerant, comprising:
a. placing a volume of whole cow's milk, which has already been pasteurized, into a stainless steel container, which has a loose fitting lid;
b. adding granulated sugar to the volume of whole cow's milk at a ratio of 10-30 grams of sugar per liter of milk to form a solution;
c. adding to the resulting solution Saccharomyces cervisiae, beer brewing top yeast, at a ratio of 2-8 grams of the yeast per liter of whole milk;
d. heating the solution to between 15 and 38 degrees Celsius and holding it at that temperature range for 6 to 12 hours;
e. raising the temperature of the solution to 60-70 degrees Celsius and holding it there for 40 minutes.

2. The improved method for treating pasteurized whole cow's milk of claim 1, wherein the last step is comprised of raising the temperature of the solution to 120 degrees Celsius for 2 seconds.

3. A cow's milk product prepared by:
a. placing a volume of whole cow's milk, which has already been pasteurized, into a stainless steel container, which has a loose fitting lid;
b. adding granulated sugar to the volume of whole cow's milk at a ratio of 10-30 grams of sugar per liter of milk to form a solution;
c. adding to the resulting solution Saccharomyces cervisiae, beer brewing top yeast, at a ratio of 2-8 grams of the yeast per liter of whole milk;
d. heating the solution to between 15 and 38 degrees Celsius and holding it at that temperature range for 6 to 12 hours;
e. raising the temperature of the solution to 60-70 degrees Celsius and holding it there for 40 minutes.

4. The cow's milk product of claim 3, wherein the last step is comprised of raising the temperature of the solution to 120 degrees Celsius for 2 seconds.

5. An improved method for treating pasteurized whole cow's milk, so that it is more digestible to persons who are lactose intolerant, comprising:
a. placing a volume of whole cow's milk, which has already been pasteurized, into a stainless steel container, which has a loose fitting lid;
b. adding granulated sugar to the volume of whole cow's milk at a ratio of 10 grams of sugar per liter of milk to form a solution;
c. adding to the resulting solution Saccharomyces cervisiae, beer brewing top yeast, at a ratio of 2 grams of the yeast per liter of whole milk;
d. heating the solution to 15 degrees Celsius and holding it at that temperature range for 12 hours;
e. raising the temperature of the solution to 60-70 degrees Celsius and holding it there for 40 minutes.

6. An improved method for treating pasteurized whole cow's milk, so that it is more digestible to persons who are lactose intolerant, comprising:
a. placing a volume of whole cow's milk, which has already been pasteurized, into a stainless steel container, which has a loose fitting lid;
b. adding granulated sugar to the volume of whole cow's milk at a ratio of 30 grams of sugar per liter of milk to form a solution;
c. adding to the resulting solution Saccharomyces cervisiae, beer brewing top yeast, at a ratio of 8 grams of the yeast per liter of whole milk;
d. heating the solution to 38 degrees Celsius and holding it at that temperature range for 6 hours;
e. raising the temperature of the solution to 60-70 degrees Celsius and holding it there for 40 minutes.

7. The process of claim 1 wherein Fleischmann's Bread Yeast is added to the solution rather than Saccharomyces cervisiae, beer brewing top yeast.

8. The product of claim 3 wherein Fleischmann's Bread Yeast is added to the solution rather than Saccharomyces cervisiae, beer brewing top yeast.

9. A cow's milk product prepared by
a. placing a volume of whole cow's milk, which has already been pasteurized, into a stainless steel container, which has a loose fitting lid;
b. adding granulated sugar to the volume of whole cow's milk at a ratio of 10 grams of sugar per liter of milk to form a solution;
c. adding to the resulting solution Saccharomyces cervisiae, beer brewing top yeast, at a ratio of 2 grams of the yeast per liter of whole milk;
d. heating the solution to 15 degrees Celsius and holding it at that temperature range for 12 hours;
e. raising the temperature of the solution to 60-70 degrees Celsius and holding it there for 40 minutes.

10. A cow's milk product prepared by
a. placing a volume of whole cow's milk, which has already been pasteurized, into a stainless steel container, which has a loose fitting lid;
b. adding granulated sugar to the volume of whole cow's milk at a ratio of 30 grams of sugar per liter of milk to form a solution;
c. adding to the resulting solution Saccharomyces cervisiae, beer brewing top yeast, at a ratio of 8 grams of the yeast per liter of whole milk;
d. heating the solution to 38 degrees Celsius and holding it at that temperature range for 6 hours;
e. raising the temperature of the solution to 60-70 degrees Celsius and holding it there for 40 minutes.

11. The product of claim 9 wherein Fleischmann's Bread Yeast is added to the solution rather than Saccharomyces cervisiae, beer brewing top yeast.

12. The product of claim 10 wherein Fleischmann's Bread Yeast is added to the solution rather than Saccharomyces cervisiae, beer brewing top yeast.

13. The improved method for treating pasteurized whole cow's milk of claim 5, wherein the last step is comprised of raising the temperature of the solution to 120 degrees Celsius for 2 seconds.

14. The improved method for treating pasteurized whole cow's milk of claim 6, wherein the last step is comprised of raising the temperature of the solution to 120 degrees Celsius for 2 seconds.
